(19) United States
(12) Patent Application Publication
(10) Pub. No.: US 2010/0060462 A1
(43) Pub. Date: Mar. 11, 2010

(54) Led rescue light

(75) Inventors: Jerrell Penn Hollaway, Melbourne, FL (US); Forrest Owen Gary, Melbourne, FL (US); Kenneth James Campbell, Melbourne, FL (US)

Correspondence Address: Jerrell P. Hollaway, 3636 Woodstock CT., Melbourne, FL, 32904, US

(73) Assignee: Revere Supply Co., Inc.

(21) Appl. No.: 12/231,968

(22) Filed: Sep. 9, 2008

(51) Int. Cl. G08B 23/00

(52) U.S. Cl. 340/573.6

(57) ABSTRACT

The present invention describes a rescue light with a LED light source that meets a minimum requirement of 0.75 candela (cd) of intensity, over a full hemisphere of visibility, with a duration of 8 hours or more. The invention requires only 3 volts of battery power from relatively small batteries, making the invention small and lightweight. In one favorite embodiment the LED is a specially constructed device that uses a blue LED die enclosed with a uniform layer of phosphor on the outer surface of the LED body, which provides an equally bright white light in all directions. Due to the low power requirements of the LED, the device can easily produce white light over an entire hemisphere at the required brightness level for longer than the required amount of time. In another favorite embodiment, a power LED with a large viewing angle is powered with a relatively high current, so as to meet the requirements for intensity over the entire hemisphere, but the high current is applied for only short periods of time in order to meet the requirement for duration. In this second embodiment, a novel switching arrangement is provided to allow the user to turn the LED on and off by changing positions of a movable member of the device, where the original position of the movable member is independent of the operational state of the device. In a third favorite embodiment, multiple LEDs are incorporated for greater visibility, and the operational state of the device is changed by pressing a momentary switch. In all of the described embodiments, a water sensitive switch may be provided to activate the LED on contact with a body of water.

### BACKGROUND OF THE INVENTION

1. Field of the Invention

The present invention relates to rescue and safety lights used in personal safety equipment in boats, ships, and airplanes.

2. Description of Related Art

Various types of rescue lights have been developed for use in marine and air rescue operations. For example, a small battery powered light is often attached to life vests and constructed such that it will be activated upon contact with water. The amount of light that can be produced with a fixed battery power source is limited by the amount of time that the light must continue to be visible. The United States Coast Guard, for example, requires that a rescue light have at least 0.75 candela (cd) of intensity over the entire hemisphere and that this light will be visible at this level for at least 8 hours.

Until recently, the light source for various rescue lights has been a small wattage incandescent light bulb. The resistance of the bulb must be carefully selected to give the minimum required intensity while at the same time not depleting the energy in the battery before the minimum time has elapsed.

The balancing act between intensity and duration would not be so critical if large batteries could be used. Unfortunately, large batteries are not practical in a rescue application. It is very desirable to use no more than two batteries of the AA size or a single 3 Volt battery such as the C 123 type for battery power.

One approach to this problem of intensity and duration can be seen in U.S. Pat. No. 5,237,491 where the light appears brighter in a tightly focused beam. The need for hemispheric coverage can only be satisfied by movement of the device in the water. Constant hemispheric coverage is not provided.

LEDs have been used in rescue lights with limited success. One product is known to use a side-emitting LED. This product meets the requirement for intensity near the 0 degree and 180 degree points of coverage, but it is deficient near the 90 degree point—often where aircraft might be searching. Furthermore, an LED of sufficient power to meet the minimum requirements for brightness cannot meet the duration requirement with small batteries unless it is flashed on and off to conserve the batteries.

### SUMMARY OF THE INVENTION

The present invention teaches practical methods of using low power LEDs in personal safety devices. The problem of providing constant hemispheric coverage, at the USCG requirement of 0.75 cd, for a minimum duration of 8 hours, while using small batteries, is solved by using a novel LED product that is actually a blue LED die within an epoxy body with a phosphor coating on the outside of the body.

Another way of solving this problem is to drive an LED with large amounts of current, but with a short duty cycle. The USCG requires that this second method—of flashing the LED to conserve battery life—have a switch that can be used to stop the flashing. A novel switching arrangement is taught where a movable member of the device can be used to stop or start the flashing, regardless of the current position of the switch.

### BRIEF DESCRIPTION OF THE DRAWINGS

FIG. 1 is a preferred embodiment of a signaling device without a switch that uses a low power LED.

FIG. 2 is another preferred embodiment of a signaling device with a switch and a high power LED.

FIG. 3 illustrated the use of a diode to create two distinct switching positions while connected to the same battery polarity.

FIG. 4 illustrates the use of multiple LEDs, a momentary push button switch, and a housing cover with an area modified for ease in activation of the switch.

### DETAILED DESCRIPTIONS OF PERFERRED EMBODIMENTS

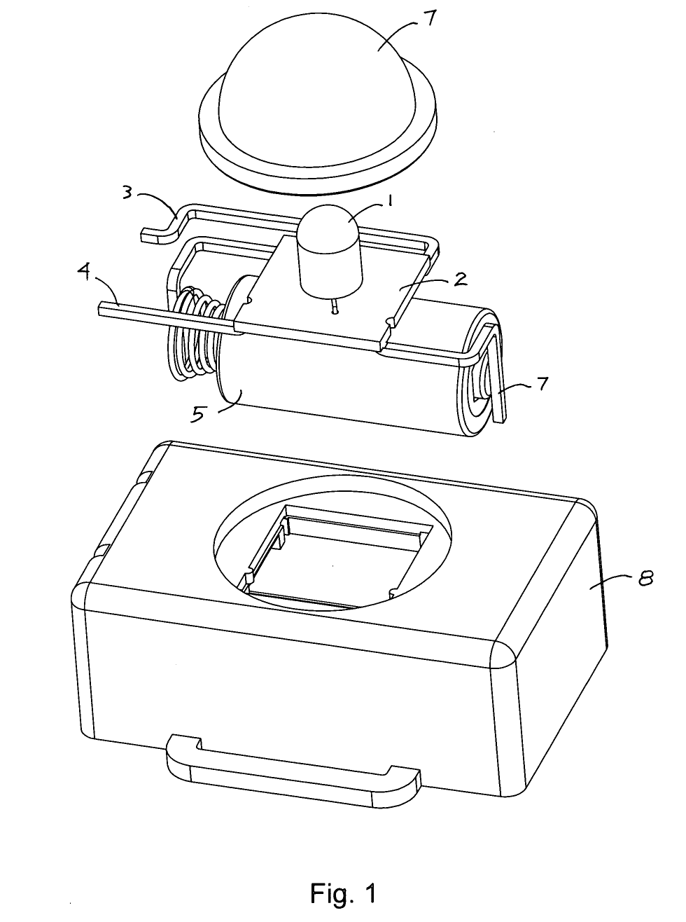

Referring now to FIG. 1, low power LED 1 is attached to circuit board 2 which is populated with a microprocessor and other electronic components designed to create a water sense circuit and a Voltage boost circuit which is used to supply operating Voltage and regulated current to LED 1. Connectors 6 and 7 are used to connect battery 5 to circuit board 2. Connectors 3 and 4 are positioned to be connected to the water sense circuit on circuit board 2 and any water present outside the walls of housing 8. Circuit board 2, LED 1, battery 5, and connectors 3, 4, 6, and 7 are contained inside housing 8 and held in place by cover 7.

In operation, whenever water sense connectors 3 and 4 come in contact with water, the water sense circuit send a signal to the boost circuit causing LED 1 to be energized. As long as water is present, LED 1 will continue to be energized. If the water is removed, LED 1 will be turn off in a few minutes and circuit board 2 will enter a sleep mode of operation to conserve battery power.

A switch is not required in this preferred embodiment, since LED 1 will supply the minimum level of brightness, 0.75 cd, for longer than the required time of 8 hours, without being used in a flashing mode of operation. This is possible because LED 1 is a low power device that achieves it's uniform hemispheric coverage by it's construction. The type of LED used in this embodiment is a special type that is made by placing a blue LED chip inside an epoxy body and then coating the body with a phosphor that will produce white light when the blue light from the chip hits the phosphor. Normally, to produce white light, a phosphor coating is placed directly on the chip—not on the outside of the epoxy body, but it is this unique placement of the phosphor that produces the uniform light pattern over 180 degrees.

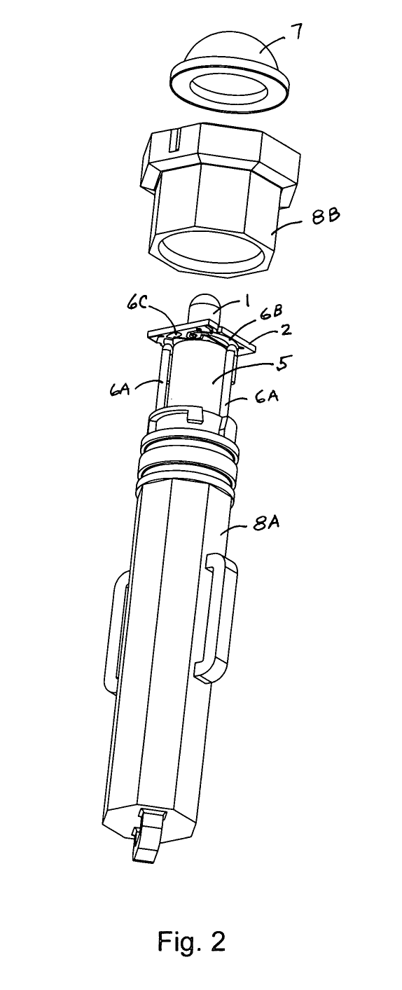

Referring now to FIG. 2, high power LED 1 is attached to circuit board 2 which is populated with a microprocessor and other electronic components designed to create a water sense circuit, a switch logic circuit, and a Voltage boost circuit used to supply Voltage and regulate current to LED 1. One end of battery 5 contacts circuit board 2 directly while the other end of battery 5 contacts circuit board 2 by way of connector 6A at conductive surfaces 6B and 6C on circuit board 2. Circuit board 2 and LED 1 are contained in housing 8b and held in place by cover 7. Battery 5 and connector 6A are contained within housing 8A.

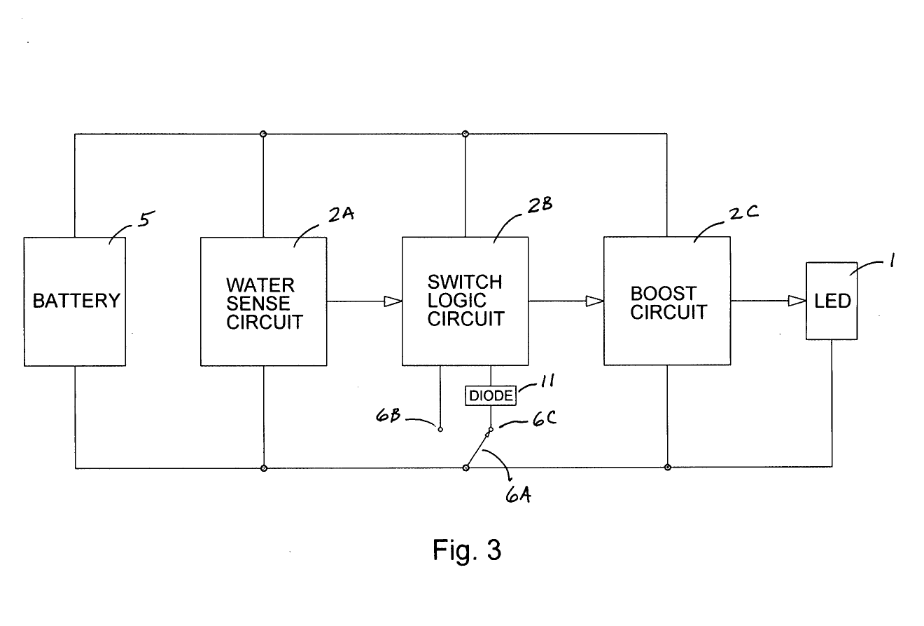

In operation, housing 8A and housing 8B are moved relative to each other such that connector 6A comes into contact with conductive surfaces 6B and 6C at different times. FIG. 3 illustrates the use of diode 11 in one of two circuit paths for one polarity of battery 5. A switching action between contacts 6A, 6B, and 6C is accomplished by rotating housing 8A and 8B, as illustrated in FIG. 2. In effect, the device has two “on” positions, where power is constantly applied to circuit board 2, but a slightly different voltage levels in each position due to the voltage drop of diode 11.

Referring again to FIG. 3, switch logic circuit 2B detects a change in voltage as contact 6A moves back and forth between contacts 6B and 6C. This change can then trigger a change in modes of operation. For example, if the LED is off, a change can turn the LED on. If the LED is on due to water on the sensors, a change can turn the LED off. Other possible mode changes would be to cause the LED to flash, or to stay on steadily instead of flashing.

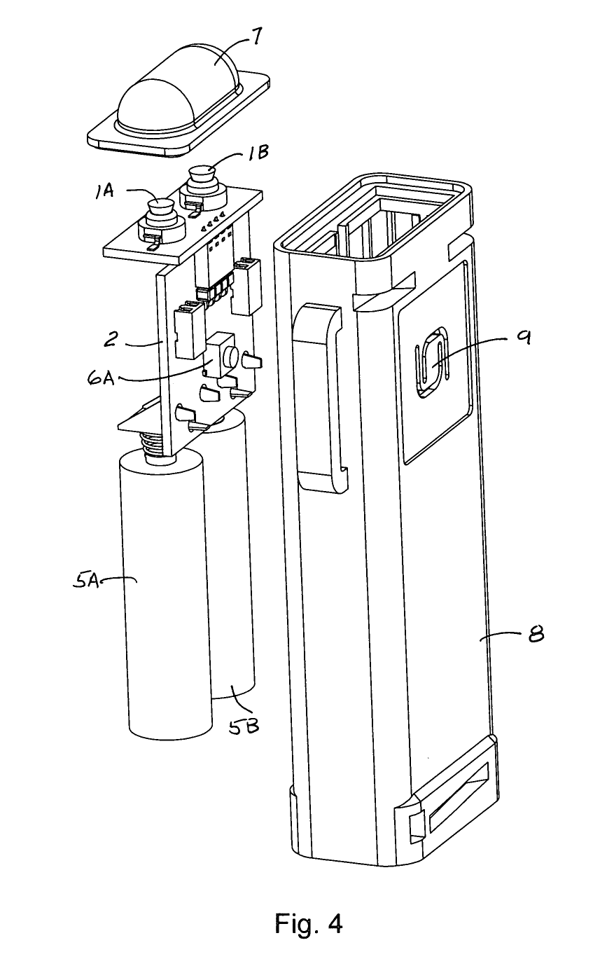

Referring to FIG. 4, another favorite embodiment shows power LED 1A and power LED 1B connected to circuit board 2 and batteries 5A and 5B. Switch 6A is a momentary switch that rotates through different modes of operation with each activation, similar to the modes found in the description of FIG. 3. Cutout 9 in housing 8 allows activation of switch 6A through a flexible porting of housing 8.

What is claimed is:

1. A signaling device that provides a steady, non-flashing, light of at least 0.75 candela brightness in a uniform hemispheric coverage for at least 8 hours with 3 Volts or less of battery power.

2. The device in claim 1, wherein said light is produced by LED means comprised of a blue LED chip inside a body means with an external coating on said body which contains phosphor, which, in combination, produces a visible white light of essentially equal brightness over an entire hemisphere.

3. The device in claim 2, wherein said 3 Volts of battery power is increased to the operating Voltage of said LED means by a boost circuit means capable of regulating current through said LED means to a prescribed amount of current.

4. The device in claim 2, wherein said LED means is comprised of two or more individual LEDs.

5. The device in claim 1, wherein said device includes water sensing means to activate said light when said device is in contact with water.

6. The device of claim 1, wherein certain of said contact positions interface with a conductive surface of a circuit board in one said portions of said housing and others of said contacts are in another of said portions of said housing.

7. The device in claim 1, wherein said device comprises a sleep mode of operation used to conserve said battery power after a prescribed period of inactivity.

8. A flashing signaling device with multiple modes of operation wherein said device provides a light of at least 0.75 candela brightness in a uniform hemispheric coverage for at least 8 hours with 3 Volts or less of battery power.

9. The device in claim 8, wherein said light is produced by one or more power LEDs.

10. The device in claim 8, wherein said 3 Volts of battery power is increased to the operating Voltage of said LED means by a boost circuit means capable of regulating current through said LED means to a prescribed amount of current.

11. The device in claim 8, wherein said device includes water sensing means to activate said light when said device is in contact with water.

12. The device in claim 8, wherein said device includes switch means used to manually select different modes of operation.

13. The device in claim 12, wherein said switch means comprises a momentary contact switch means used to rotate through two or more of said different modes of operation with each activation of said switch.

14. The device of claim 13, wherein said switch means is manually activated through a flexible portion of the housing of said device.

15. The device of claim 12, wherein said switch means comprises two or more contact positions which may be selected by moving two portions of the housing of said device relative to each other.

16. The device of claim 15, wherein certain of said contact positions are on the surface of a circuit board in one said portions of said housing and others of said contacts are in another of said portions of said housing

17. The device of claim 16, wherein certain of said contacts are unique because of different Voltages present on said certain contacts, thereby making movement between one of said contacts and another of said certain contacts easily identifiable.

18. The device of claim 17, wherein said different Voltages are established by inserting a diode between the battery and one or more of certain contacts.

19. The device in claim 8, wherein said device comprises a sleep mode of operation used to conserve said battery power after a prescribed period of inactivity.
